(19) United States
(12) Patent Application Publication
(10) Pub. No.: US 2018/0176820 A1
(43) Pub. Date: Jun. 21, 2018

(54) SYSTEMS AND METHODS FOR IMMEDIATE TRANSMISSION AFTER CLEAR CHANNEL ASSESSMENT

(71) Applicant: QUALCOMM Incorporated, San Diego, CA (US)

(72) Inventors: Paul DenBoer, Escondido, CA (US); Huibert DenBoer, Escondido, CA (US); Sriraman Chari, Fremont, CA (US); William McFarland, Portola Valley, CA (US)

(21) Appl. No.: 15/381,831

(22) Filed: Dec. 16, 2016

(51) Int. Cl. H04W 28/04; H04W 4/00; H04W 72/10; H04L 7/033

(52) U.S. Cl. CPC H04W 28/044; H04W 4/008; H04L 49/109; H04L 7/033; H04W 72/10

(57) ABSTRACT

A method is described. The method includes receiving a clear channel assessment (CCA) using a first radio configured for a first communication protocol. The method also includes reconfiguring a second radio configured for a second communication protocol for transmission of the first communication protocol. The method further includes transmitting immediately using the second radio after receiving the CCA, wherein a CCA measurement indicates that a channel is clear.

### TECHNICAL FIELD

The present disclosure relates generally to communications. More specifically, the present disclosure relates to systems and methods for immediate transmission after clear channel assessment.

### BACKGROUND

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices. More specifically, wireless communication devices that perform new functions and/or that perform functions faster, more efficiently or more reliably are often sought after.

Advances in technology have resulted in smaller and more powerful wireless communication devices. For example, there currently exist a variety of wireless communication devices such as portable wireless telephones (e.g., smartphones) personal digital assistants (PDAs), laptop computers, tablet computers, paging devices and sensors that are each small, lightweight, and can be easily carried by users or mounted in a fixed location.

A wireless communication device may be configured to perform a clear channel assessment (CCA) to determine whether a channel is clear before transmitting. During the CCA, the wireless communication device may use a receiver in a radio to measure energy in the channel. If the channel is clear, then the wireless communication device may reconfigure the radio to transmit. However, during the time it takes to reconfigure the radio, another device may transmit on the same channel, which may result in collisions in the signals. Benefits may be realized by immediate transmission after CCA.

### SUMMARY

A method is described. The method includes receiving a clear channel assessment (CCA) using a first radio configured for a first communication protocol. The method also includes reconfiguring a second radio configured for a second communication protocol for transmission of the first communication protocol. The method further includes transmitting immediately using the second radio after receiving the CCA, wherein a CCA measurement indicates that a channel is clear.

The first radio and the second radio may be included in a single system-on-chip (SoC). The first radio and the second radio may be in separate integrated circuits.

The second radio may transmit on the same channel as the CCA received by the first radio. The first communication protocol may be IEEE 802.15.4 and the second communication protocol may be Bluetooth Low Energy.

The method may also include determining that the first communication protocol has priority over the second communication protocol. The method may further include halting or aborting operations of the second communication protocol upon determining that the first communication protocol has priority over the second communication protocol. The method may also include reconfiguring the second radio for transmission of the first communication protocol upon determining that the first communication protocol has priority over the second communication protocol.

A wireless communication device is also described. The wireless communication device includes a first radio configured for a first communication protocol. The first radio receives a CCA. The wireless communication device also includes a second radio configured for a second communication protocol. The wireless communication device further includes a radio reconfiguration module that reconfigures the second radio for transmission of the first communication protocol. The second radio transmits immediately after the first radio receives the CCA and a CCA measurement indicates that a channel is clear.

The wireless communication device may also include a coexistence manager that determines whether the first communication protocol has priority over the second communication protocol. The coexistence manager may halt or abort operations of the second communication protocol upon determining that the first communication protocol has priority over the second communication protocol. The radio reconfiguration module may reconfigure the second radio for transmission of the first communication protocol when the coexistence manager determines that the first communication protocol has priority over the second communication protocol.

A computer-program product is also described. The computer-program product includes a non-transitory computer-readable medium having instructions thereon. The instructions include code for causing a wireless communication device to receive a CCA using a first radio configured for a first communication protocol. The instructions also include code for causing the wireless communication device to reconfigure a second radio configured for a second communication protocol for transmission of the first communication protocol. The instructions further include code for causing the wireless communication device to transmit immediately using the second radio after receiving the CCA. A CCA measurement indicates that a channel is clear.

An apparatus is also described. The apparatus includes means for receiving a CCA using a first radio configured for a first communication protocol. The apparatus also includes means for reconfiguring a second radio configured for a second communication protocol for transmission of the first communication protocol. The apparatus further includes means for transmitting immediately using the second radio after receiving the CCA. A CCA measurement indicates that a channel is clear.

A method is also described. The method includes receiving a CCA using a radio having a first phase lock loop (PLL) configured for reception and a second PLL configured for transmission. The method also includes transmitting immediately using the second PLL after receiving the CCA. A CCA measurement indicates that a channel is clear.

The transmitting may occur on a same channel as the CCA. The radio may be configured for an IEEE 802.15.4 communication protocol.

A wireless communication device is also described. The wireless communication device includes a radio having a first PLL configured for reception and a second PLL configured for transmission. The radio receives a CCA using the first PLL. The radio transmits immediately using the second PLL after receiving the CCA when a CCA measurement indicates that a channel is clear.

A computer-program product is also described. The computer-program product includes a non-transitory computer-readable medium having instructions thereon. The instructions include code for causing a wireless communication device to receive a CCA using a radio having a first PLL configured for reception and a second PLL configured for transmission. The instructions also include code for causing the wireless communication device to transmit immediately using the second PLL after receiving the CCA when a CCA measurement indicates that a channel is clear.

An apparatus is also described. The apparatus includes means for receiving a CCA using a radio having a first PLL configured for reception and a second PLL configured for transmission. The apparatus also includes means for transmitting immediately using the second PLL after receiving the CCA when a CCA measurement indicates that a channel is clear.

### BRIEF DESCRIPTION OF THE DRAWINGS

FIG. 1 is a block diagram illustrating a wireless communication device configured for immediate transmission after a clear channel assessment (CCA);

FIG. 2 is a flow diagram illustrating a configuration of a method for immediate transmission after CCA;

FIG. 3 is a flow diagram illustrating another configuration of a method for immediate transmission after CCA;

FIG. 4 is a flow diagram illustrating yet another configuration of a method for immediate transmission after CCA;

FIG. 5 is a block diagram illustrating another configuration of a wireless communication device configured for immediate transmission after a CCA;

FIG. 6 is a flow diagram illustrating another configuration of a method for immediate transmission after CCA; and

FIG. 7 illustrates certain components that may be included within a wireless communication device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

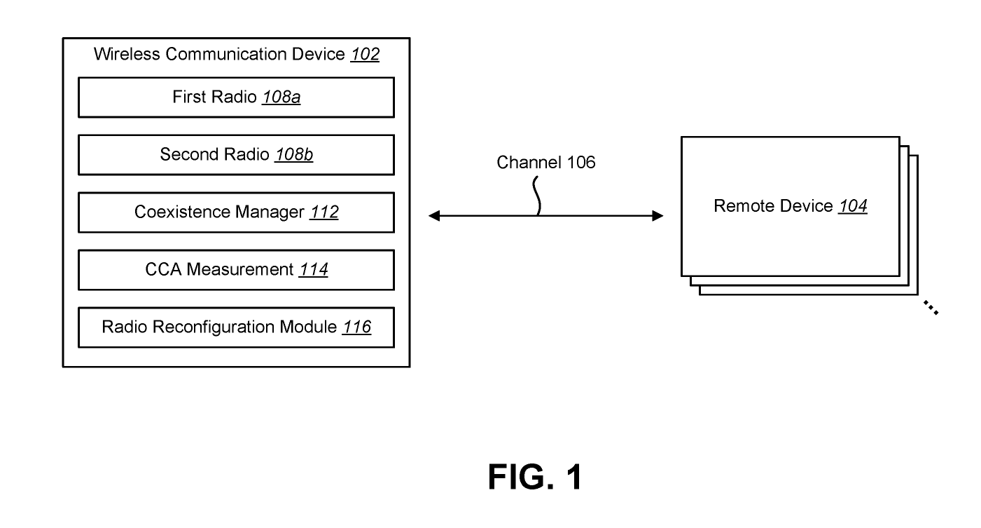

FIG. 1 is a block diagram illustrating a wireless communication device 102 configured for immediate transmission after a clear channel assessment (CCA). The wireless communication device 102 may communicate with one or more remote devices 104.

Some wireless communication devices 102 may utilize multiple communication technologies or protocols. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, IEEE 802.15.4 (e.g., Zigbee) networks, wireless Universal Serial Bus (USB) networks, etc.).

Communications in a wireless communication system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A wireless communication device 102 is an electrical device that is configured to communicate using one or more communication protocols. A wireless communication device 102 may also be referred to as a wireless device, a mobile device, mobile station, subscriber station, client, client station, user equipment (UE), remote station, access terminal, mobile terminal, terminal, user terminal, subscriber unit, etc. Examples of wireless communication devices 102 include laptop or desktop computers, cellular phones, smartphones, wireless modems, e-readers, tablet devices, gaming systems, keyboards, keypads, computer mice, remote controllers, headsets, smoke detectors, sensors, etc.

In an implementation, the wireless communication device 102 may be configured to communicate using a first communication protocol and a second communication protocol. The first communication protocol may be an Institute of Electrical and Electronics Engineers (IEEE) 802.15.4 protocol. Examples of protocols that are based on IEEE 802.15.4 include ZigBee, ISA100.11a, WirelessHART, MiWi, and Thread specifications. IEEE 802.15.4 may be used to establish a wireless personal area network (WPAN) that is characterized by low-cost, low-speed communication between devices. IEEE 802.15.4 devices may use one of three possible frequency bands (i.e., channels 106) for operation (e.g., 868/915/2450 MHz). As used herein, the term “communication protocol” may also be referred to as a radio access technology.

In IEEE 802.15.4, multiple devices may form a network that does not require synchronization between devices, which may be referred to as a non-beacon enabled personal area network (PAN). An IEEE 802.15.4 non-beaconed enabled PAN is by definition a network that does not require synchronization between devices. For this reason the CCA needs to be performed before a transmit, as discussed below.

For a wireless communication device 102 in an IEEE 802.15.4 network to talk to a remote device 104, both the wireless communication device 102 and the remote device 104 join the network. The wireless communication device 102 may then communicate with a remote device 104 on a wireless channel 106. In certain IEEE 802.15.4 networks, all devices use the same channel 106 to communicate.

The second communication protocol may be Bluetooth or Bluetooth Low Energy (BLE). Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel 106).

Communications in a Bluetooth network may be achieved based on a master polled system. The master polled system may utilize time-division duplexing (TDD) in which a wireless communication device 102 may send a packet to a remote device 104. For example, the wireless communication device 102 may send a packet to the remote device 104 during pairing or during a connection request. In one implementation, the wireless communication device 102 may be a master device and the remote device 104 may be a slave device. In a master polled system, the wireless communication device 102 sending the packet gives the slave wireless device the ability to transmit back.

The Bluetooth wireless communication standard is typically employed for exchanging communications between fixed or mobile Bluetooth-enabled devices over short distances. In some configurations, the systems and methods disclosed herein may be applied to Bluetooth Low Energy (BLE) devices. LE refers to the “Low Energy” extension of the Bluetooth standard. The BLE extension is focused on energy-constrained applications such as battery-operated devices, sensor applications, etc. The BLE extension may also be referred to as Bluetooth Smart.

The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices 102 that may not conform to Bluetooth standards.

While IEEE 802.15.4 and Bluetooth have been described, other communication protocols may be used. For example, the wireless communication device 102 may also use WiFi to communicate with a remote device 104.

Some communication protocols (including IEEE 802.15.4 and WiFi) perform contention-based transmission. Before a wireless communication device 102 can transmit on a channel 106, the wireless communication device 102 determines whether another remote device 104 is currently transmitting on the channel. The wireless communication device 102 may perform a clear channel assessment (CCA) to determine whether a channel 106 is clear or busy. As used herein a channel 106 is a band of frequencies that may be used for wireless communication. It should be noted that Bluetooth is a non-contention network that does not require CCA.

During CCA, a receiver of the wireless communication device 102 may detect energy on a given channel 106. This energy measurement is referred to as a CCA measurement 114. If the CCA measurement 114 is above a given energy threshold, then the channel 106 is considered to be busy, in which case the wireless communication device 102 will back off transmission. If the CCA measurement 114 is below the energy threshold, then the channel 106 is considered to be clear and the wireless communication device 102 may proceed with a transmission on the channel 106. It should be noted that other methods exist besides energy measurements to perform CCA in order to decide if a channel 106 is busy or clear.

It should be noted that a wireless communication device 102 must use a receiver in a radio 108 to receive a CCA. A radio 108 may include a transmit (TX) path and a receive (RX) path. A radio 108 may also include a phase lock loop (PLL) that may be used to adjust a received signal channel 106 or a transmitted signal channel 106. The radio 108 may be configured for receiving signals or transmitting signals. This may include configuring the PLL of the radio 108 for reception or transmission.

A wireless communication device 102 may experience problems in a contention-based network where the wireless communication device 102 must perform CCA before transmitting. For a wireless communication device 102 with one radio 108, a problem exists where the PLL of the radio 108 needs to be reconfigured from a receive (RX) frequency for a CCA to a transmit (TX) frequency for transmission. This recalibration takes a certain amount of time, and will result in a lag between the CCA and the transmission. With an all-digital PLL (ADPLL) the situation gets even worse as it takes even longer for the PLL to calibrate and lock, as opposed to an analog PLL. Thus, during this reconfiguration time, another remote device 104 can pass CCA and could transmit on the channel 106. This may increase the probability of on-air transmission (i.e., TX/TX) collisions.

The problem with collisions is especially high in an IEEE 802.15.4 network. Because all devices in an IEEE 802.15.4 network transmit on the same channel 106, the likelihood of collision is higher than in a network (e.g., BLE network) that employs frequency hopping.

It should be noted that using an analog PLL (as opposed to an ADPLL) may decrease the lag between CCA and transmission, but will not eliminate the lag completely. However, the use of ADPLLs may be beneficial in certain applications. For example, in energy limited devices (e.g., battery powered devices), ADPLLs may provide better energy efficiency. ADPLLs are also smaller than analog PLLs, which may decrease manufacturing costs and may allow for smaller wireless communication devices 102.

The systems and methods described herein provide for immediate transmission after clear channel assessment (CCA). In the implementation described in connection with FIG. 1, a wireless communication device 102 may be configured with a dual radio 108a-b solution. A first radio 108a may be configured to communicate using a first communication protocol. A second radio 108b may be configured to communicate using a second communication protocol. For example, the first radio 108a may be configured as an IEEE 802.15.4 radio and the second radio 108b may be configured as a Bluetooth Low Energy radio.

In an example, the wireless communication device 102 may be used for home automation or home networking. For instance, the wireless communication device 102 may be a sensor that communicates with other sensors in a home personal area network environment using IEEE 802.15.4 (e.g., Zigbee or Thread protocol). Bluetooth communication may also be implemented in the wireless communication device 102. For example, a user may interface with the wireless communication device 102 from a computer or smartphone using Bluetooth.

It should be noted that the second radio 108b must be able to tune to a frequency in the band that is being used for the first communication protocol and should be able to allow the transmit path to be able to transmit data according to physical layer specification of the first communication protocol. For example, Bluetooth Low Energy and IEEE 802.15.4 are very similar at the radio level. In fact, a single system-on-chip may be built with two equivalent radios 108 in it, a first radio 108a for IEEE 802.15.4 and the second radio 108b for Bluetooth. In this case, these two protocols are very similar at the physical layer (i.e., the radios 108a-b are identical). However, other communication protocols (e.g., Wi-Fi, LTE, etc.) may be used as long as their frequency ranges overlap.

In an implementation, the first radio 108a and the second radio 108b may be on the same system-on-chip (SoC). This implementation has the benefit of simplifying communication complexity. With multiple radios 108, a modem must steer signals between the first radio 108a and the second radio 108b. With a single SoC, the signals sent between the modem and the radios 108 are exchanged in a single integrated circuit. A single SoC solution may also reduce the physical size and cost of the wireless communication device 102.

In another implementation, the first radio 108a and the second radio 108b may be in separate integrated circuits. This may provide flexibility in the design of the wireless communication device 102. However, this implementation may add signaling complexity. The modem of the wireless communication device 102 must coordinate between the separate integrated circuits. In some cases (when the integrated circuits are manufactured by different entities), the integrated circuits may not be able to communicate with each other.

The wireless communication device 102 may initiate a CCA using the first radio 108a that is configured for the first communication protocol. For example, the receiver of the first radio 108a may be turned on and the energy on a channel 106 may be measured for a period of time.

The wireless communication device 102 may include a radio reconfiguration module 116. The radio reconfiguration module 116 may be implemented as hardware (e.g., circuitry), software executed by a processor, or a combination of hardware and software.

Attorney Docket No. 163376

While the CCA is being received by the first radio 108a, the radio reconfiguration module 116 may reconfigure the second radio 108b for transmission of the first communication protocol. In other words, the radio reconfiguration module 116 may prepare the second radio 108b to start the TX process in anticipation of a clear CCA. This may include tuning the PLL of the second radio 108b to the transmit frequency (i.e. channel 106) of the first communication protocol while the CCA measurement is still in progress.

As soon as the wireless communication device 102 determines that the CCA measurement 114 indicates that the channel 106 is clear, the wireless communication device 102 may immediately transmit using the second radio 108b. The wireless communication device 102 transmits using the first communication protocol on the same channel 106 (i.e., in the same frequency band) as the CCA received by the first radio 108a. Therefore, the wireless communication device 102 can use both radios 108a-b to quickly switch between the CCA receive and the transmission.

In an exemplary implementation, the first radio 108a may be configured for IEEE 802.15.4 and the second radio 108b may be configured for BLE. To determine whether an IEEE 802.15.4 transmission can proceed on a channel 106, the wireless communication device 102 may perform CCA using the first radio 108a. While the CCA is being performed, the radio reconfiguration module 116 may reconfigure the second radio 108b from BLE to transmission of IEEE 802.15.4. When the CCA measurement 114 indicates that the channel 106 is clear, the wireless communication device 102 may immediately send an IEEE 802.15.4 transmission using the second radio 108b.

In an implementation, the wireless communication device 102 may include a coexistence manager 112. The coexistence manager 112 may determine that the first communication protocol has priority over the second communication protocol. For example, an IEEE 802.15.4 message may have priority over a BLE message.

The coexistence manager block 112 may be responsible for ensuring that both the first and second communication protocol can interoperate when using the same (or similar) medium or channel 106. The coexistence manager block 112 may also communicate with external devices (e.g., such as a WiFi integrated circuit) that are co-located in the same wireless communication device 102. This communication interface allows all three protocols to interoperate, or coexist, on the same (or similar) medium or channel 106.

To interoperate, the coexistence manger 112 needs to know which channel 106 or medium each communication protocol will be using. In most cases, the coexistence manager 112 needs to also know which similar or adjacent channels 106 will be used by some of the protocols that can interfere with the main channel 106 of interest.

Each transmission and reception for a particular protocol serves a unique function. Some of these functions are low priority while others are high priority. The priority level is often communicated by the CPU that executes the protocol and schedules the transmit or receive functions. In other cases, the hardware can automatically schedule a transmit or receive function (e.g., hardware can automatically generate an acknowledgement (ACK) response to another device). Normally, functions such as an acknowledgement (ACK) for a transmit or receive is a high priority event. Other events like a BLE advertisement is normally a low priory event.

In an implementation, each communication protocol, via CPU instruction messages or through dedicated hardware busses, may communicate the priority of each respective transmit or receive to the coexistence manager 112.

In another implementation, each communication protocol, via CPU instruction messages or through dedicated hardware busses, may communicate the actual type of function to the coexistence manager 112. In this second implementation the coexistence manager 112 then has a predefined priority associated with each type of function, and therefore can decide which communication protocol or function has priority.

In yet another implementation the coexistence manager 112 inside of the SoC might be a slave to another coexistence manager inside of another external device (e.g., a WiFi integrated circuit). In this implementation the SoC communicates its status to the external integrated circuit by requesting access to the channel 106. The external integrated circuit can then respond with an acknowledgement indicator to signal that the SoC can use the channel 106. The external integrated circuit can also respond with a busy indicator that signals to the SoC that the channel 106 is not available for use.

Upon determining that the first communication protocol has priority over the second communication protocol, the coexistence manager 112 may suspend operations of the second communication protocol. For example, the coexistence manager 112 may halt or abort a pending or current transmission or reception on the second radio 108b for the second communication protocol to allow for transmission of the first communication protocol on the first radio 108a.

Upon determining that the first communication protocol has priority over the second communication protocol, the radio reconfiguration module 116 may reconfigure the second radio 108b for transmission of the first communication protocol. As described above, this may include tuning the PLL of the second radio 108b to the transmit frequency of the first communication protocol.

It should be noted that in the case of a single SoC that includes the multiple radios 108a-b, when a transmission occurs, the transmit power may be too great and the isolation too small that the receive path of the other radio needs to be disabled. In this case, simultaneous TX/RX is not supported. Therefore, a single SoC solution lends itself well to the systems and methods for immediate transmission after CCA described herein. Because the reception already does not occur during transmission of an SoC, there is no risk for a reception on the second communication protocol during the transmission of the first communication protocol. Therefore, the single SoC solution described herein provides minimal impact on the coexistence of the first and second communication protocols.

The systems and methods described herein reduce the probability of on-air collisions. The described systems and methods also improve the throughput of the entire first communication protocol system. This is especially beneficial for an IEEE 802.15.4 system where the devices use a single channel 106 to communicate. The described systems and methods use hardware to make a transition from a CCA to a TX much faster by using multiple PLLs.

The systems and methods described herein may also save cost and improve energy efficiency. ADPLLs may be used in the radios 108, which are less expensive and require less energy than analog PLLs. This may be very beneficial for battery powered wireless communication devices 102.

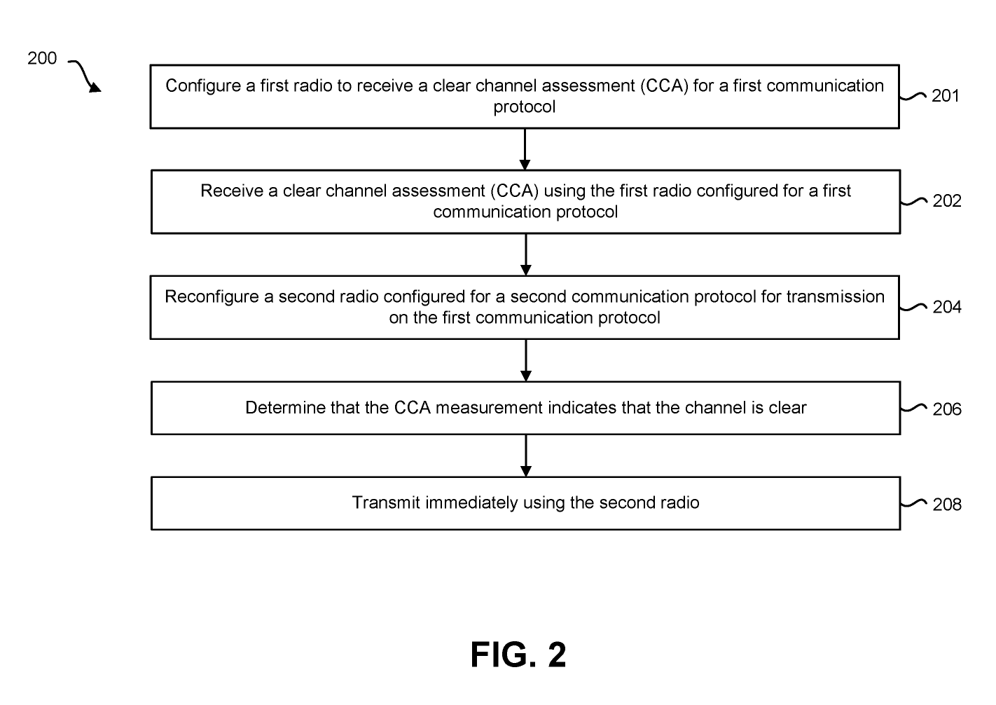

FIG. 2 is a flow diagram illustrating a configuration of a method 200 for immediate transmission after clear channel assessment (CCA). The method 200 may be performed by a wireless communication device 102. The wireless communication device 102 may be configured with a first radio 108a and a second radio 108b. In an implementation, the first radio 108a and the second radio 108b are included in a single system-on-chip (SoC). In another implementation, the first radio 108a and the second radio 108b are in separate integrated circuits.

The first radio 108a may be configured 201 to receive a CCA for a first communication protocol. The second radio 108b may be configured for a second communication protocol. In an implementation, the first communication protocol is IEEE 802.15.4 and the second communication protocol is Bluetooth Low Energy.

The wireless communication device 102 may receive 202 a CCA using the first radio 108a configured for the first communication protocol. For example, before a transmission using the first communication protocol, the wireless communication device 102 may perform a CCA to determine whether the channel 106 is clear for the transmission.

The wireless communication device 102 may reconfigure 204 the second radio 108b for transmission of the first communication protocol. For example, while the CCA is being received 202 by the first radio 108a, the wireless communication device 102 may reconfigure 204 the second radio 108b for transmission of the first communication protocol. The wireless communication device 102 may tune the PLL of the second radio 108b to the transmit frequency of the channel 106 used by the first communication protocol.

The wireless communication device 102 may determine 206 that the CCA measurement 114 indicates that the channel 106 is clear. For example, the CCA measurement 114 may be below an energy threshold for a busy channel.

The wireless communication device 102 may transmit 208 immediately using the second radio 108b. As soon as the wireless communication device 102 determines 206 that the CCA measurement 114 indicates that the channel 106 is clear, the wireless communication device 102 may immediately transmit 208 using the second radio 108b. The wireless communication device 102 transmits 208 using the first communication protocol on the same channel 106 (i.e., in the same frequency band) as the CCA received by the first radio 108a.

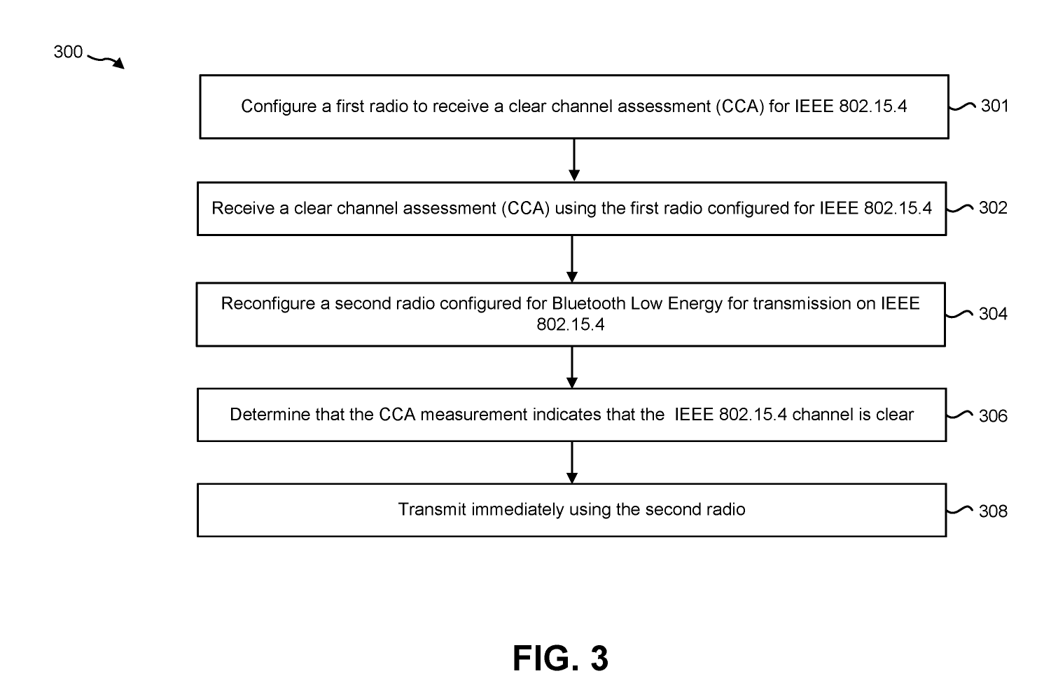

FIG. 3 is a flow diagram illustrating another configuration of a method 300 for immediate transmission after CCA. The method 300 may be performed by a wireless communication device 102. The wireless communication device 102 may be configured with a first radio 108a and a second radio 108b.

The wireless communication device 102 may configure 301 the first radio 108a to receive a CCA for IEEE 802.15.4. The first radio 108a may be configured for IEEE 802.15.4. The second radio 108b may be configured for Bluetooth Low Energy.

The wireless communication device 102 may receive 302 a CCA using the first radio 108a configured for IEEE 802.15.4. For example, before an IEEE 802.15.4 transmission, the wireless communication device 102 may perform a CCA to determine whether the channel 106 used for an IEEE 802.15.4 transmission is clear.

The wireless communication device 102 may reconfigure 304 the second radio 108b that is currently configured for Bluetooth Low Energy for transmission of IEEE 802.15.4. For example, while the CCA is being received 302 by the first radio 108a, the wireless communication device 102 may tune the PLL of the second radio 108b to the transmit frequency of the channel 106 used by IEEE 802.15.4.

The wireless communication device 102 may determine 306 that the CCA measurement 114 indicates that the IEEE 802.15.4 channel 106 is clear. The wireless communication device 102 may transmit 308 immediately using the second radio 108b. The wireless communication device 102 immediately transmits 308 using the IEEE 802.15.4 protocol on the same channel 106 as the CCA received by the first radio 108a.

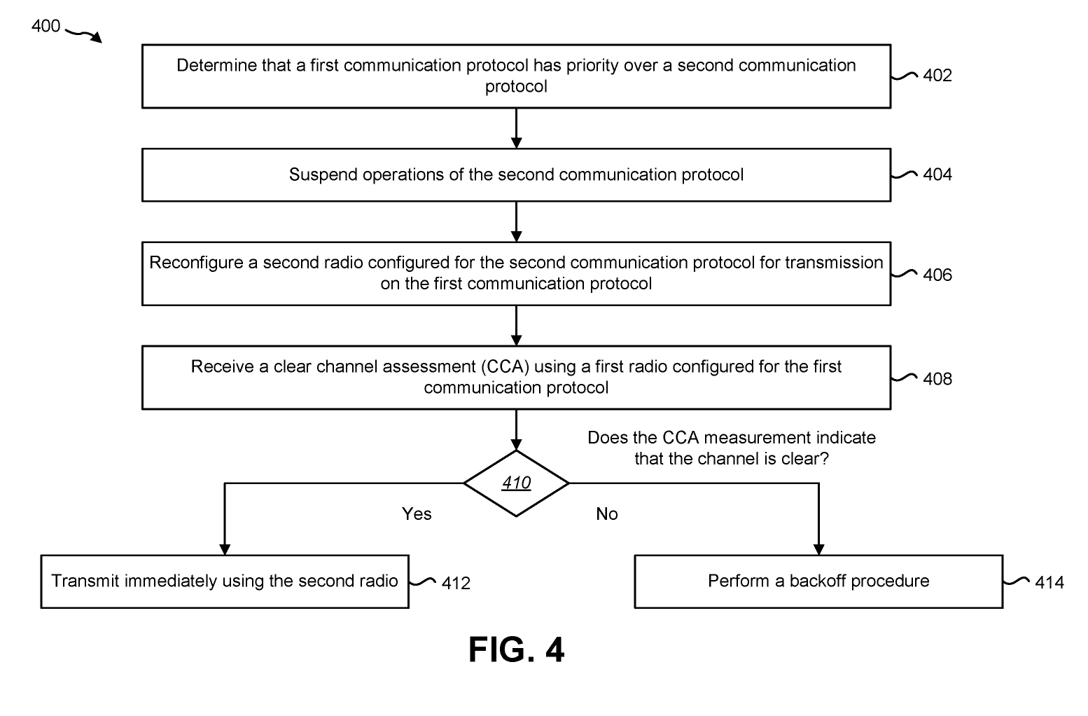

FIG. 4 is a flow diagram illustrating yet another configuration of a method 400 for immediate transmission after CCA. The method 400 may be performed by a wireless communication device 102. The wireless communication device 102 may be configured with a first radio 108a and a second radio 108b. The first radio 108a may be configured for a first communication protocol. The second radio 108b may be configured for a second communication protocol.

The wireless communication device 102 may determine 402 that the first communication protocol has priority over the second communication protocol. For example, a coexistence manager 112 may determine that a transmission of the first communication protocol has a higher priority than transmission or reception on the second communication protocol.

The wireless communication device 102 may suspend 404 operations of the second communication protocol. For example, the coexistence manager 112 may halt or abort a pending or current transmission or reception on the second radio 108b for the second communication protocol to allow for transmission of the first communication protocol.

The wireless communication device 102 may reconfigure 406 the second radio 108b for transmission of the first communication protocol. This may include tuning the PLL of the second radio 108b to the transmit frequency of the first communication protocol.

The wireless communication device 102 may receive 408 a CCA using the first radio 108a configured for the first communication protocol. For example, before a transmission using the first communication protocol, the wireless communication device 102 may perform a CCA to determine whether the channel 106 for the transmission is clear.

The wireless communication device 102 may determine 410 whether the CCA measurement 114 indicates that the channel 106 is clear. For example, if the CCA measurement 114 is below an energy threshold, the channel 106 may be considered clear. If the CCA measurement 114 indicates that the channel 106 is clear, then the wireless communication device 102 may transmit 412 immediately using the second radio 108b. The wireless communication device 102 may transmit 412 using the first communication protocol on the same channel 106 as the CCA received by the first radio 108a.

If the wireless communication device 102 determines 410 that the CCA measurement 114 does not indicate that the channel 106 is clear (i.e., the channel 106 is busy), then the wireless communication device 102 may perform 414 a backoff procedure. For example, the wireless communication device 102 may wait a random amount of time before performing another CCA procedure for transmission. In this case, the wireless communication device 102 may reconfigure the second radio 108b back to the second communication protocol. Alternatively, the wireless communication device 102 may keep the second radio 108b configured for the first communication protocol in the event that the channel 106 is clear after the backoff time has expired.

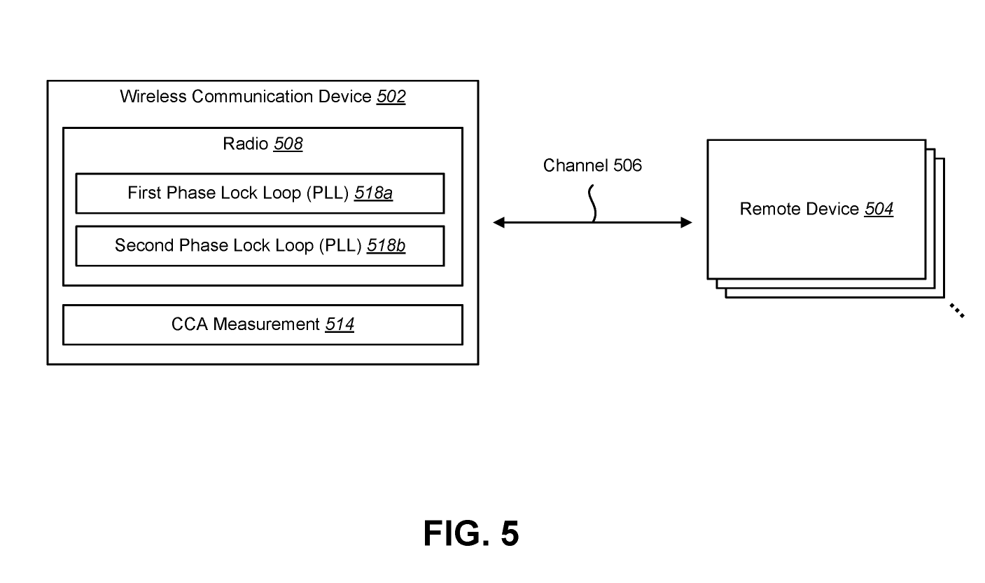

FIG. 5 is a block diagram illustrating another configuration of a wireless communication device 502 configured for immediate transmission after a CCA. The wireless communication device 502 may be implemented in accordance with the wireless communication device 102 described in connection with FIG. 1. However, in this configuration, the wireless communication device 502 may have a single radio 508 with two phase lock loops (PLLs) 518.

The wireless communication device 502 may use the radio 508 to communicate with one or more remote devices 504. The radio 508 may be configured for one or more communication protocols. For example, the radio 508 may be configured to perform IEEE 802.15.4 communication. Alternatively, the radio 508 may be configured to perform multiple communication protocols (e.g., IEEE 802.15.4, BLE, Wi-Fi, etc.) in a time sharing manner.

This configuration of the wireless communication device 502 addresses the problem of the lag between reconfiguring a single PLL 518 from an RX frequency for a CCA to a TX frequency for transmission. Instead of having a single PLL 518, the radio 508 has separate PLLs 518 for reception and transmission.

In an implementation, a first PLL 518a may be configured for reception. In this case, the first PLL 518a may be tuned to the receive frequency of a given channel 506. The second PLL 518b may be configured for transmission. In this case, the second PLL 518b may be tuned to the transmit frequency of the channel 506.

The wireless communication device 502 may receive a CCA using the first PLL 518a configured for reception. The wireless communication device 502 may determine whether the CCA measurement 514 indicates that the channel 506 is clear.

If the channel 506 is clear, the wireless communication device 502 may immediately transmit using the second PLL 518b. The transmission may occur on the same channel 506 as the CCA. Because the second PLL 518b was preconfigured (e.g., tuned) for transmission, the wireless communication device 502 may avoid a lag between the CCA reception and the transmission.

It should be noted that having multiple PLLs 518 may increase the size and cost of the radio 508. Therefore, if a wireless communication device 502 includes multiple radios 508, then the solution described in connection with FIG. 1 may be more efficient. However, the solution described in connection with FIG. 5 may be advantageous when a single radio 508 is desired.

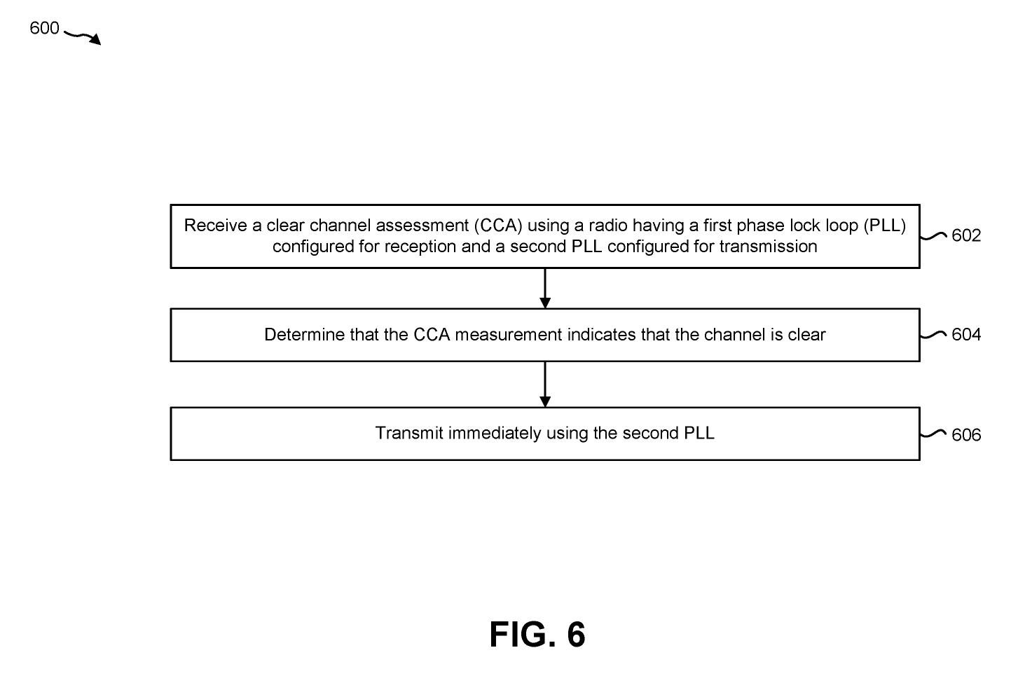

FIG. 6 is a flow diagram illustrating another configuration of a method 600 for immediate transmission after CCA. The method 600 may be performed by a wireless communication device 502. The wireless communication device 502 may be configured with a radio 508 that includes a first PLL 518a and a second PLL 518b.

The first PLL 518a may be configured for reception. In this case, the first PLL 518a may be tuned to the receive frequency of a given channel 506. The second PLL 518b may be configured for transmission. In this case, the second PLL 518b may be tuned to the transmit frequency of the channel 506.

The wireless communication device 502 may receive 602 a CCA using the first PLL 518a configured for reception. For example, before a transmission using the first communication protocol, the wireless communication device 502 may perform a CCA to determine whether the channel 506 is clear for the transmission.

The wireless communication device 502 may determine 604 that the CCA measurement 514 indicates that the channel 506 is clear. For example, the CCA measurement 514 may be below an energy threshold for a busy channel.

The wireless communication device 502 may transmit 606 immediately using the second PLL 518b. The wireless communication device 502 transmits 606 on the same channel 506 (i.e., in the same frequency band) as the CCA received by the radio 508 using the first PLL 518a.

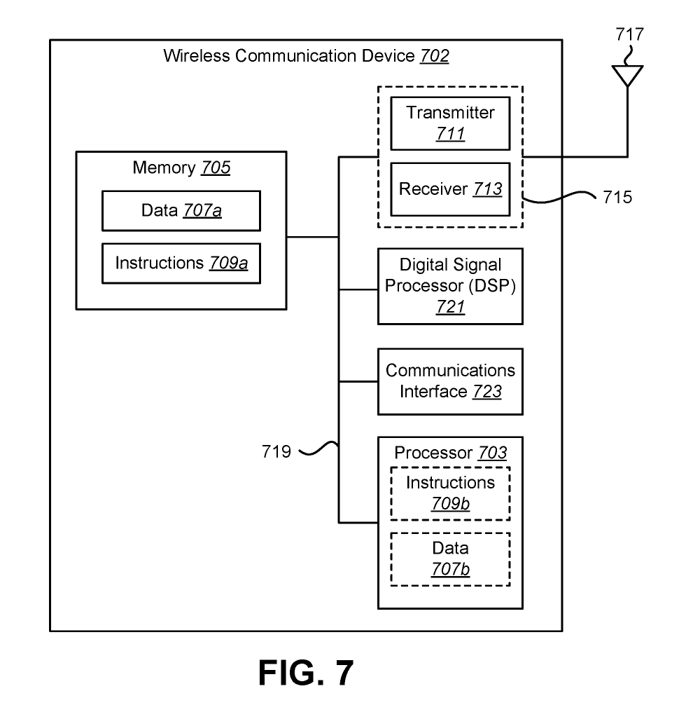

FIG. 7 illustrates certain components that may be included within a wireless communication device 702. The wireless communication device 702 described in connection with FIG. 7 may be an example of and/or may be implemented in accordance with the wireless communication device 102 described in connection with one or more of FIGS. 1-7.

The wireless communication device 702 includes a processor 703. The processor 703 may be a general purpose single- or multi-core microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705 in electronic communication with the processor 703 (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, erasable programmable read-only (EPROM) memory, electrically erasable programmable read-only (EEPROM) memory, registers and so forth, including combinations thereof.

Data 707a and instructions 709a may be stored in the memory 705. The instructions 709a may include one or more programs, routines, sub-routines, functions, procedures, code, etc. The instructions 709a may include a single computer-readable statement or many computer-readable statements. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. It should be noted that as used herein, a “transceiver” is synonymous with “radio.” The wireless communication device 702 may also include (not shown) multiple transmitters, multiple antennas, multiple receivers and/or multiple transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
receiving a clear channel assessment (CCA) using a first radio configured for a first communication protocol;
reconfiguring a second radio configured for a second communication protocol for transmission of the first communication protocol; and
transmitting immediately using the second radio after receiving the CCA, wherein a CCA measurement indicates that a channel is clear.

2. The method of claim 1, wherein the first radio and the second radio are included in a single system-on-chip (SoC).

3. The method of claim 1, wherein the first radio and the second radio are in separate integrated circuits.

4. The method of claim 1, wherein the second radio transmits on a same channel as the CCA received by the first radio.

5. The method of claim 1, wherein the first communication protocol is IEEE 802.15.4 and the second communication protocol is Bluetooth Low Energy.

6. The method of claim 1, further comprising determining that the first communication protocol has priority over the second communication protocol.

7. The method of claim 6, further comprising halting or aborting operations of the second communication protocol upon determining that the first communication protocol has priority over the second communication protocol.

8. The method of claim 6, further comprising reconfiguring the second radio for transmission of the first communication protocol upon determining that the first communication protocol has priority over the second communication protocol.

9. A wireless communication device, comprising:
a first radio configured for a first communication protocol, wherein the first radio receives a clear channel assessment (CCA);
a second radio configured for a second communication protocol; and
a radio reconfiguration module that reconfigures the second radio for transmission of the first communication protocol, wherein the second radio transmits immediately after the first radio receives the CCA and a CCA measurement indicates that a channel is clear.

10. The wireless communication device of claim 9, wherein the first radio and the second radio are included in a single system-on-chip (SoC).

11. The wireless communication device of claim 9, wherein the second radio transmits on a same channel as the CCA received by the first radio.

12. The wireless communication device of claim 9, wherein the first communication protocol is IEEE 802.15.4 and the second communication protocol is Bluetooth Low Energy.

13. The wireless communication device of claim 9, further comprising a coexistence manager that determines whether the first communication protocol has priority over the second communication protocol.

14. The wireless communication device of claim 13, wherein the coexistence manager halts or aborts operations of the second communication protocol upon determining that the first communication protocol has priority over the second communication protocol.

15. The wireless communication device of claim 13, wherein the radio reconfiguration module reconfigures the second radio for transmission of the first communication protocol when the coexistence manager determines that the first communication protocol has priority over the second communication protocol.

16. A computer-program product, the computer-program product comprising a non-transitory computer-readable medium having instructions thereon, the instructions comprising:
code for causing a wireless communication device to receive a clear channel assessment (CCA) using a first radio configured for a first communication protocol;
code for causing the wireless communication device to reconfigure a second radio configured for a second communication protocol for transmission of the first communication protocol; and
code for causing the wireless communication device to transmit immediately using the second radio after receiving the CCA, wherein a CCA measurement indicates that a channel is clear.

17. The computer-program product of claim 16, wherein the first radio and the second radio are included in a single system-on-chip (SoC).

18. The computer-program product of claim 16, wherein the second radio transmits on a same channel as the CCA received by the first radio.

19. The computer-program product of claim 16, wherein the first communication protocol is IEEE 802.15.4 and the second communication protocol is Bluetooth Low Energy.

20. The computer-program product of claim 16, further comprising code for causing the wireless communication device to determine that the first communication protocol has priority over the second communication protocol.

21. The computer-program product of claim 20, further comprising code for causing the wireless communication device to halt or abort operations of the second communication protocol upon determining that the first communication protocol has priority over the second communication protocol.

22. The computer-program product of claim 20, further comprising code for causing the wireless communication device to reconfigure the second radio for transmission of the first communication protocol upon determining that the first communication protocol has priority over the second communication protocol.

23. An apparatus, comprising:
means for receiving a clear channel assessment (CCA) using a first radio configured for a first communication protocol;
means for reconfiguring a second radio configured for a second communication protocol for transmission of the first communication protocol; and
means for transmitting immediately using the second radio after receiving the CCA, wherein a CCA measurement indicates that a channel is clear.

24. The apparatus of claim 23, wherein the first radio and the second radio are included in a single system-on-chip (SoC).

25. The apparatus of claim 23, wherein the second radio transmits on a same channel as the CCA received by the first radio.

26. The apparatus of claim 23, wherein the first communication protocol is IEEE 802.15.4 and the second communication protocol is Bluetooth Low Energy.

27. The apparatus of claim 23, further comprising means for determining that the first communication protocol has priority over the second communication protocol.

28. The apparatus of claim 27, further comprising means for halting or aborting operations of the second communication protocol upon determining that the first communication protocol has priority over the second communication protocol.

29. The apparatus of claim 27, further comprising means for reconfiguring the second radio for transmission of the first communication protocol upon determining that the first communication protocol has priority over the second communication protocol.

30. A method, comprising:
receiving a clear channel assessment (CCA) using a radio having a first phase lock loop (PLL) configured for reception and a second PLL configured for transmission; and
transmitting immediately using the second PLL after receiving the CCA when a CCA measurement indicates that a channel is clear.

31. The method of claim 30, wherein the transmitting occurs on a same channel as the CCA.

32. The method of claim 30, wherein the radio is configured for an IEEE 802.15.4 communication protocol.

33. A wireless communication device, comprising:
a radio having a first phase lock loop (PLL) configured for reception and a second PLL configured for transmission, wherein the radio receives a clear channel assessment (CCA) using the first PLL, and wherein the radio transmits immediately using the second PLL after receiving the CCA when a CCA measurement indicates that a channel is clear.

34. A computer-program product, the computer-program product comprising a non-transitory computer-readable medium having instructions thereon, the instructions comprising:
code for causing a wireless communication device to receive a clear channel assessment (CCA) using a radio having a first phase lock loop (PLL) configured for reception and a second PLL configured for transmission; and
code for causing the wireless communication device to transmit immediately using the second PLL after receiving the CCA when a CCA measurement indicates that a channel is clear.

35. An apparatus, comprising:
means for receiving a clear channel assessment (CCA) using a radio having a first phase lock loop (PLL) configured for reception and a second PLL configured for transmission; and
means for transmitting immediately using the second PLL after receiving the CCA when a CCA measurement indicates that a channel is clear.
